(19) United States
(12) Patent Application Publication
(10) Pub. No.: US 2026/0175171 A1
(43) Pub. Date: Jun. 25, 2026

(54) PROCESS FOR DESULFURIZATION, DECARBONIZATION, AND CO PURIFICATION OF BLAST FURNACE GAS

(71) Applicants: FUZHOU UNIVERSITY, Fuzhou (CN); Fujian province Sinogasholder Equipment Installation Co., Ltd., Fuzhou (CN)

(72) Inventors: Lilong JIANG, Fuzhou (CN); Yong ZHENG, Fuzhou (CN); Minghong WU, Fuzhou (CN); Yanning CAO, Fuzhou (CN); Fujian LIU, Fuzhou (CN); Shiqiu LIU, Fuzhou (CN)

(73) Assignees: FUZHOU UNIVERSITY, Fuzhou (CN); Fujian province Sinogasholder Equipment Installation Co., Ltd., Fuzhou (CN)

(21) Appl. No.: 19/418,005

(22) Filed: Dec. 12, 2025

(30) Foreign Application Priority Data
Dec. 19, 2024 (CN) 202411883913.2

(51) Int. Cl. B01D 53/75; B01D 53/04; B01D 53/047; B01D 53/26

(52) U.S. Cl. CPC B01D 53/75; B01D 53/0407; B01D 53/047; B01D 53/26; B01D 2253/104; B01D 2253/106; B01D 2253/1124; B01D 2257/102; B01D 2257/2025; B01D 2257/304; B01D 2257/306; B01D 2257/502; B01D 2257/504; B01D 2257/80

(57) ABSTRACT

A process for desulfurization, decarbonization, and CO purification of blast furnace gas. The process includes introducing blast furnace gas into a pretreatment device for low-temperature dehydration, dust removal and dechlorination; introducing a pretreated blast furnace gas sequentially into a primary, a secondary and a tertiary decarbonization and desulfurization adsorption devices filled with large-grained adsorbents for decarbonization and desulfurization treatment to remove carbon dioxide, hydrogen sulfide and carbonyl sulfur from the blast furnace gas, wherein the tertiary decarbonization and desulfurization adsorption device is sprayed with salt-free water, the secondary decarbonization and desulfurization adsorption device is sprayed with a certain concentration of ammonia water, and the primary decarbonization and desulfurization adsorption device is sprayed with a certain concentration of low-carbonation ammonia water; introducing the blast furnace gas after the decarbonization and desulfurization treatment into a pressure swing adsorption CO purification device to separate CO and nitrogen and purify high-concentration CO gas.

### TECHNICAL FIELD

The present invention relates to the fields of energy conservation and emission reduction technology in the steel industry and steel-chemical co-production technology, specifically to a process for desulfurization, decarbonization, and CO purification of blast furnace gas.

### BACKGROUND

According to statistics, the steel industry in China is the manufacturing sector with the highest carbon emissions, accounting for approximately 15% of China's total carbon emissions. In response to the goals set by the state for various industries, the steel industry is trying its best to save energy and reduce carbon emissions. In the steel industry, blast furnace gas is mainly used as fuel gas for regenerative hot blast stoves, power generation, and as fuel gas for processes such as steel rolling when blended with coke oven gas or converter gas. It has low added value and is a high-carbon emission fuel. Therefore, how to make high-value-added comprehensive utilization of blast furnace gas and reduce steel production costs has always been an important issue of concern for steel companies. CN221051806U discloses a method that couples an activated carbon adsorption desulfurization and deacidification system with an organic amine absorption and carbon dioxide capture system to achieve fine desulfurization and carbon dioxide capture and emission reduction of blast furnace gas, while obtaining high-calorific-value blast furnace gas. This achieves the goal of low-cost, high-efficiency, and low-energy-consumption treatment of blast furnace gas. CN115196590A discloses an economical, reasonable, simple and feasible process for carbon capture and hydrogen production from blast furnace gas; CN221822122U discloses a system for the co-production of methanol and LNG from blast furnace gas and coke oven gas, which can maximize the comprehensive utilization of various effective components in steel plant gas, etc. However, the above technologies all involve high-energy-consuming methods such as compressing blast furnace gas or using organic amine absorption of carbon dioxide. How to remove carbon from the gas with low energy consumption and produce CO gas as a byproduct is still a problem that needs to be solved.

### SUMMARY OF THE INVENTION

To address the problems existing in the aforementioned carbon-emission reduction technologies in steel plants, the present invention discloses a process for desulfurization, decarbonization, and CO purification of blast furnace gas. By filling an adsorption tower with multi-stage, multi-layered large-grained adsorbents, the adsorption and flow-guiding effects of the large-grained adsorbents increase the residence time of acidic gases in the blast furnace gas within the adsorption tower, thereby effectively promoting the reaction between ammonia and acidic gases. This improves the removal rate of sulfur species and carbon dioxide from the blast furnace gas by ammonia, while simultaneously producing ammonium bicarbonate, achieving the true requirements of desulfurization and decarbonization. Then, pressure swing adsorption is used to increase the CO concentration, allowing the high-concentration CO to be used as a raw material for other chemical synthesis, thus realizing high-value-added utilization of blast furnace gas.

The present invention adopts the following technical solution:

A process for desulfurization, decarbonization, and CO purification of blast furnace gas comprises the following steps:
S1, introducing blast furnace gas into a pretreatment device for low-temperature dehydration, dust removal and dechlorination;
S2, introducing a pretreated blast furnace gas sequentially into a primary decarbonization and desulfurization adsorption device, a secondary decarbonization and desulfurization adsorption device, and a tertiary decarbonization and desulfurization adsorption device filled with large-grained adsorbents for decarbonization and desulfurization treatment to remove carbon dioxide, hydrogen sulfide and carbonyl sulfur from the blast furnace gas, wherein the tertiary decarbonization and desulfurization adsorption device is sprayed with salt-free water, the secondary decarbonization and desulfurization adsorption device is sprayed with a certain concentration of ammonia water, and the primary decarbonization and desulfurization adsorption device is sprayed with a certain concentration of low-carbonation ammonia water;
S3, introducing the blast furnace gas after the decarbonization and desulfurization treatment into a pressure swing adsorption CO purification device to separate CO and nitrogen and purify high-concentration CO gas.

In step S1, the dehydration, dust removal and dechlorination of the blast furnace gas in the pretreatment device comprises low-temperature chilled-water cooling along with the removal of water, chloride ions and dust, wherein a drain outlet is provided at the bottom of the pretreatment device, and the temperature of the blast furnace gas after cooling treatment is lower than 15° C.

The low-temperature is in the range of 0-5° C.

In step S1, the lower part of the side wall of the pretreatment unit is provided with a chilled-water inlet, and the upper part of the side wall of the pretreatment unit is provided with a warm water outlet; cold energy for heat exchange with the blast furnace gas is supplied through the chilled-water inlet, and the warm water after heat exchange is discharged from the warm water outlet.

Each stage of the decarbonization and desulfurization adsorption device in step S2 is filled with three layers of large-grained adsorbents in the form of solid spheres, hollow spheres, or pebble-shaped pellets with different diameters, the adsorbent has the function of simultaneously adsorbing carbon dioxide, hydrogen sulfide, and carbonyl sulfide, the blast furnace gas is input from the bottom of the side wall of each stage of the decarbonization and desulfurization adsorption device and output from the top of the side wall of each stage of the decarbonization and desulfurization adsorption device.

Preferably, the three layers of adsorbents in each stage of the decarbonization and desulfurization adsorption device are that, the adsorbent in the upper layer has a diameter of 40-50 mm, the adsorbent in the middle layer has a diameter of 30-40 mm, and the adsorbent in the lower layer has a diameter of 20-30 mm.

Preferably, the adsorbent in step S2 is a composite porous adsorbent made from one or more composites of carbon nitride, aluminum oxide, silica, magnesium oxide, titanium oxide, zirconium oxide, and cerium oxide as raw materials, which is shaped and then sintered at 700-900° C.

The spray liquid used in the tertiary decarbonization and desulfurization adsorption device in step S2 is salt-free water, the liquid after being sprayed and treated by the tertiary decarbonization and desulfurization adsorption device is mixed with externally added liquid ammonia and then used as the spray liquid required by the secondary decarbonization and desulfurization adsorption device, the liquid is a mixture of ammonia water with a concentration of 15 mass %-17 mass % and ammonium carbonate with a concentration of less than 0.1 mass %; the liquid after being sprayed and treated by the secondary decarbonization and desulfurization adsorption device is used as the spray liquid required by the primary decarbonization and desulfurization adsorption device, the liquid is a mixture of ammonia water with a concentration of 10 mass %-15 mass %, ammonium carbonate with a concentration of less than 5 mass % and ammonium bicarbonate with a concentration of less than 1 mass %; after being sprayed and treated by the primary decarbonization and desulfurization adsorption device, the liquid coming out from the bottom of the primary decarbonization and desulfurization adsorption device is a mixture of ammonium bicarbonate with a concentration of 15 mass %-20 mass % and ammonium carbonate with a concentration of less than 1 mass %.

Preferably, the top of the primary decarbonization and desulfurization adsorption device is provided with a first spray liquid inlet for introducing spray liquid, and the bottom of the primary decarbonization and desulfurization adsorption device is provided with a first spray liquid outlet for discharging spray liquid; the top of the secondary decarbonization and desulfurization adsorption device is provided with a second spray liquid inlet for introducing spray liquid, and the bottom of the secondary decarbonization and desulfurization adsorption device is provided with a second spray liquid outlet for discharging spray liquid; the top of the tertiary decarbonization and desulfurization adsorption device is provided with a third spray liquid inlet for introducing spray liquid, and the bottom of the tertiary decarbonization and desulfurization adsorption device is provided with a third spray liquid outlet for discharging spray liquid.

In step S3, the content of sulfur species in the blast furnace gas after decarbonization and desulfurization treatment is less than 5 ppm, and the content of carbon dioxide is less than 0.5 vol %; the concentration of CO gas after pressure swing adsorption separation by the pressure swing adsorption CO purification device is greater than 98.5 vol %.

The technical solution of the present invention has the following advantages:
A. The present invention effectively increases the residence time of acidic gases in blast furnace gas in the decarbonization and desulfurization adsorption device by using multi-stage, multi-layered large-grained adsorbents, thereby significantly improving the reaction efficiency of ammonia with sulfur species and carbon dioxide, and achieving efficient desulfurization and decarbonization. This innovative approach not only meets environmental protection requirements but also creates favorable conditions for subsequent CO purification steps.
B. Compared with the prior art, the process of the present invention avoids high-energy-consuming compression or the use of organic amine adsorption and other means. Through ingenious design, the entire desulfurization and decarbonization process is carried out at low temperature and normal pressure, which greatly reduces energy consumption and meets the current urgent needs for energy conservation and emission reduction.
C. While desulfurizing and decarbonizing, the present invention can also co-produce ammonium bicarbonate, which not only further improves the comprehensive utilization rate of resources, but also brings additional economic benefits to enterprises. This integrated production method is both environmentally friendly and economical, and has broad market prospects.
D. Through subsequent pressure swing adsorption steps, the present invention can purify high concentrations of CO gas. This high-value-added CO gas can be directly used as a chemical raw material to synthesize chemicals such as methanol and acetic acid, thereby further enhancing the utilization value of blast furnace gas.

### BRIEF DESCRIPTION OF THE DRAWINGS

To more clearly illustrate the specific embodiments of the present invention, the accompanying drawings used in the specific embodiments will be briefly introduced below. Obviously, the drawings described below are some embodiments of the present invention. For those skilled in the art, other drawings can be obtained from these drawings without creative effort.

FIG. 1 is a schematic diagram of the overall structure of the process for desulfurization, decarbonization, and CO purification of blast furnace gas according to the present invention.

The reference signs in the drawings are labeled as follows:
1—pretreatment device, 11—drain outlet, 12—chilled-water inlet, 13—warm water outlet; 2—primary decarbonization and desulfurization adsorption device, 21—first spray liquid inlet, 22—first spray liquid outlet; 3—secondary decarbonization and desulfurization adsorption device, 31—second spray liquid inlet, 32—second spray liquid outlet; 4—tertiary decarbonization and desulfurization adsorption device, 41—third spray liquid inlet, 42—third spray liquid outlet; 5—pressure swing adsorption CO purification device; 6—ammonia water tank; 7—low-carbonation ammonia water tank; 8—high-carbonation ammonia water tank.

### DETAILED DESCRIPTION

The technical solution of the present invention will now be clearly and completely described with reference to the accompanying drawings. Obviously, the described examples are only some examples of the present invention, and not all examples. Based on the examples of the present invention, all other examples obtained by those skilled in the art without creative effort are within the scope of protection of the present invention.

### Example 1

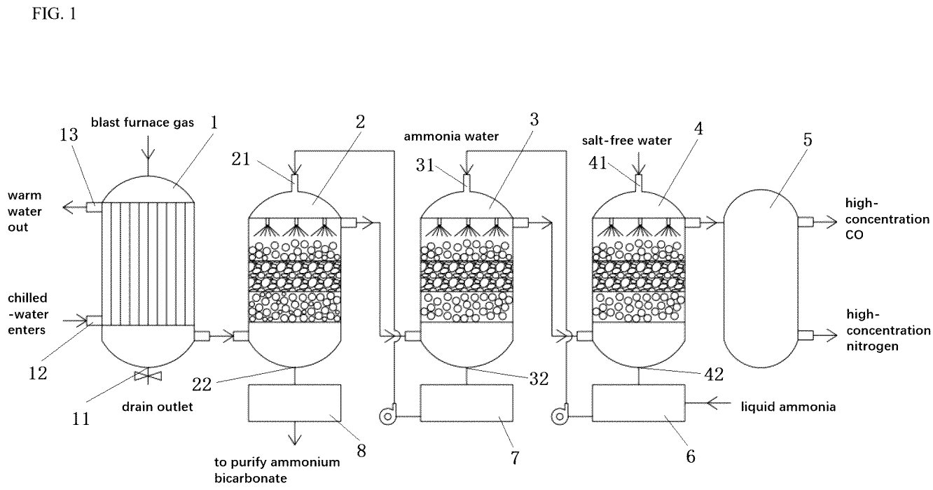

As shown in FIG. 1, this example provided a process for desulfurization, decarbonization, and CO purification of blast furnace gas, comprising the following steps:
S1, 5000 Nm³/h of blast furnace gas at 60° C. was introduced into pretreatment device 1 for dehydration, dust removal and dechlorination. The temperature of the blast furnace gas after pretreatment was 9° C.
S2, The pretreated blast furnace gas was sequentially passed through three stages of desulfurization and decarbonization adsorption devices. The three layers of adsorbents in each stage device are: the upper layer was filled with hollow spherical alumina adsorbent with a diameter of 40-50 mm, the middle layer was filled with pebble-shaped magnesium oxide adsorbent with a diameter of 30-40 mm, and the lower layer was filled with a composite adsorbent composed of spherical alumina and magnesium oxide with a diameter of 20-30 mm. All the above adsorbents were calcined in air at 700° C. for 12 hours. The tertiary decarbonization and desulfurization adsorption device 4 used salt-free water for spraying treatment. The treated spray liquid was mixed with liquid ammonia and used as the spray liquid for the secondary decarbonization and desulfurization adsorption device 3, which was a mixture (by mass) of 15% ammonia water and 0.03% ammonium carbonate. The spray liquid after treatment by the secondary decarbonization and desulfurization adsorption device 3 was a mixture (by mass) of 11% ammonia water, 3% ammonium carbonate and 0.3% ammonium bicarbonate. The solution coming out of the bottom of the primary decarbonization and desulfurization adsorption device 2 was a mixture (by mass) of 20% ammonium bicarbonate and 0.5% ammonium carbonate. The blast furnace gas, after undergoing three-stage desulfurization and decarbonization treatment, contained 5% water, 0.3% carbon dioxide, 31% carbon monoxide, and 63% nitrogen. The COS concentration was 3 ppm, and no hydrogen sulfide was detected.
S3, Finally, the blast furnace gas was passed into the pressure swing adsorption CO purification device 5 for pressure swing adsorption treatment to purify CO, and 98.9 vol % CO gas was obtained.

### Example 2

This example provided a process for desulfurization, decarbonization, and CO purification of blast furnace gas, comprising the following steps:
S1, 12000 Nm³/h of blast furnace gas at 70° C. was introduced into pretreatment device 1 for dehydration, dust removal and dechlorination. The temperature of the blast furnace gas after pretreatment was 14° C.
S2, The pretreated blast furnace gas was sequentially passed through three stages of desulfurization and decarbonization adsorption devices. The three layers of adsorbents in each stage device are: the upper layer was filled with hollow spherical zirconium oxide adsorbent with a diameter of 40-50 mm, the middle layer was filled with pebble-shaped silica adsorbent with a diameter of 30-40 mm, and the lower layer was filled with a composite adsorbent composed of spherical zirconium oxide and silica with a diameter of 20-30 mm. All the above adsorbents were calcined in air at 800° C. for 10 hours. The tertiary decarbonization and desulfurization adsorption device 4 used salt-free water for spraying treatment. The treated spray liquid was mixed with liquid ammonia and used as the spray liquid for the secondary decarbonization and desulfurization adsorption device 3, which was a mixture (by mass) of 16% ammonia water and 0.02% ammonium carbonate. The spray liquid after treatment by the secondary decarbonization and desulfurization adsorption device 3 was a mixture (by mass) of 10% ammonia water, 5% ammonium carbonate and 0.1% ammonium bicarbonate. The solution coming out of the bottom of the primary decarbonization and desulfurization adsorption device 2 was a mixture (by mass) of 15% ammonium bicarbonate and 0.3% ammonium carbonate. The blast furnace gas, after undergoing three-stage desulfurization and decarbonization treatment, contained 6% water, 0.4 vol % carbon dioxide, 32 vol % carbon monoxide, and 61 vol % nitrogen. The COS concentration was 2 ppm, and no hydrogen sulfide was detected.
S3, Finally, the blast furnace gas was passed into the pressure swing adsorption CO purification device 5 for pressure swing adsorption treatment to purify CO, and 99.1 vol % CO gas was obtained.

### Example 3

This example provided a process for desulfurization, decarbonization, and CO purification of blast furnace gas, comprising the following steps:
S1, 30000 Nm³/h of blast furnace gas at 50° C. was introduced into pretreatment device 1 for dehydration, dust removal and dechlorination. The temperature of the blast furnace gas after pretreatment was 12° C.
S2, The pretreated blast furnace gas was sequentially passed through three stages of desulfurization and decarbonization adsorption devices. The three layers of adsorbents in each stage device are: the upper layer was filled with a composite adsorbent composed of spherical cerium oxide and zirconium oxide with a diameter of 40-50 mm, the middle layer was filled with a pebble-shaped composite adsorbent composed of titanium oxide and magnesium oxide with a diameter of 30-40 mm, and the lower layer was filled with a composite adsorbent composed of spherical alumina and silica with a diameter of 20-30 mm. All the above adsorbents were calcined in air at 900° C. for 5 hours. The tertiary decarbonization and desulfurization adsorption device 4 used salt-free water for spraying treatment. The treated spray liquid was mixed with liquid ammonia and used as the spray liquid for the secondary decarbonization and desulfurization adsorption device 3, which was a mixture (by mass) of 17% ammonia water and 0.05% ammonium carbonate. The spray liquid after treatment by the secondary decarbonization and desulfurization adsorption device 3 was a mixture (by mass) of 15% ammonia water, 1% ammonium carbonate and 0.2% ammonium bicarbonate. The solution coming out of the bottom of the primary decarbonization and desulfurization adsorption device 2 was a mixture (by mass) of 18% ammonium bicarbonate and 0.4% ammonium carbonate. The blast furnace gas, after undergoing three-stage desulfurization and decarbonization treatment, contained 5% water, 0.5% carbon dioxide, 30% carbon monoxide, and 64% nitrogen. The COS concentration was 1 ppm, and no hydrogen sulfide was detected.
S3, Finally, the blast furnace gas was passed into the pressure swing adsorption CO purification device 5 for pressure swing adsorption treatment to purify CO, and 98.8 vol % CO gas was obtained.

The present invention, by filling the decarbonization and desulfurization adsorption device with multi-stage, multi-layered large-grained adsorbents, and using the adsorption and flow-guiding effects of the large-grained adsorbents, improves the removal rate of sulfur species and carbon dioxide from the blast furnace gas by ammonia, while simultaneously producing ammonium bicarbonate, achieving the true requirements of desulfurization and decarbonization. This process does not involve raising the temperature or pressure during desulfurization and decarbonization, which greatly reduces energy consumption and the process is simple. The pressure swing adsorption is used to increase the CO concentration, allowing the high-concentration CO to be used as a raw material for other chemical synthesis, thus realizing high-value-added utilization of blast furnace gas.

Any aspects not covered in the present invention are applicable to existing technologies.

Obviously, the above embodiments are merely examples for clear illustration and are not intended to limit the implementation. For those skilled in the art, other variations or modifications can be made based on the above description. It is neither necessary nor possible to exhaustively list all possible implementation methods here. However, any obvious variations or modifications derived therefrom are still within the scope of protection of the present invention.

1. A process for desulfurization, decarbonization, and CO purification of blast furnace gas, wherein the process comprises the following steps:
S1, introducing blast furnace gas into a pretreatment device (1) for low-temperature dehydration, dust removal and dechlorination;
S2, introducing a pretreated blast furnace gas sequentially into a primary decarbonization and desulfurization adsorption device (2), a secondary decarbonization and desulfurization adsorption device (3), and a tertiary decarbonization and desulfurization adsorption device (4) filled with large-grained adsorbents for decarbonization and desulfurization treatment to remove carbon dioxide, hydrogen sulfide and carbonyl sulfur from the blast furnace gas, wherein the tertiary decarbonization and desulfurization adsorption device (4) is sprayed with salt-free water, the secondary decarbonization and desulfurization adsorption device (3) is sprayed with a certain concentration of ammonia water, and the primary decarbonization and desulfurization adsorption device (2) is sprayed with a certain concentration of low-carbonation ammonia water,
wherein each stage of the decarbonization and desulfurization adsorption device in step S2 is filled with three layers of large-grained adsorbents in the form of solid spheres, hollow spheres, or pebble-shaped pellets with different diameters, the adsorbent has the function of simultaneously adsorbing carbon dioxide, hydrogen sulfide, and carbonyl sulfide, the blast furnace gas is input from the bottom of the side wall of each stage of the decarbonization and desulfurization adsorption device and output from the top of the side wall of each stage of the decarbonization and desulfurization adsorption device,
wherein the three layers of adsorbents in each stage of the decarbonization and desulfurization adsorption device are that, the adsorbent in the upper layer has a diameter of 40-50 mm, the adsorbent in the middle layer has a diameter of 30-40 mm, and the adsorbent in the lower layer has a diameter of 20-30 mm, and
wherein the adsorbent in step S2 is a composite porous adsorbent made from one or more composites of carbon nitride, aluminum oxide, silica magnesium oxide, titanium oxide, zirconium oxide, and cerium oxide as raw materials, which is shaped and the sintered at 700-900° C.; and
S3, introducing the blast furnace gas after the decarbonization and desulfurization treatment into a pressure swing adsorption CO purification device (5) to separate CO and nitrogen and purify high-concentration CO gas.

2. The process of claim 1, wherein in step S1, the dehydration, dust removal and dechlorination of the blast furnace gas in the pretreatment device (1) comprises low-temperature chilled-water cooling along with the removal of water, chloride ions and dust, wherein a drain outlet (11) is provided at the bottom of the pretreatment device (1), and the temperature of the blast furnace gas after cooling treatment is lower than 15° C.

3. The process of claim 2, wherein the low-temperature is in the range of 0-5° C.

4. The process of claim 1, wherein in step S1, the lower part of the side wall of the pretreatment unit (1) is provided with a chilled-water inlet (12), and the upper part of the side wall of the pretreatment unit (1) is provided with a warm water outlet (13); cold energy for heat exchange with the blast furnace gas is supplied through the chilled-water inlet (12), and the warm water after heat exchange is discharged from the warm water outlet (13).

5.-7. (canceled)

8. The process of claim 1, wherein the spray liquid used in the tertiary decarbonization and desulfurization adsorption device (4) in step S2 is salt-free water, the liquid after being sprayed and treated by the tertiary decarbonization and desulfurization adsorption device (4) is mixed with externally added liquid ammonia and then used as the spray liquid required by the secondary decarbonization and desulfurization adsorption device (3), the liquid is a mixture of ammonia water with a concentration of 15%-17 mass % and ammonium carbonate with a concentration of less than 0.1 mass %; the liquid after being sprayed and treated by the secondary decarbonization and desulfurization adsorption device (3) is used as the spray liquid required by the primary decarbonization and desulfurization adsorption device (2), the liquid is a mixture of ammonia water with a concentration of 10 mass %-15 mass %, ammonium carbonate with a concentration of less than 5 mass % and ammonium bicarbonate with a concentration of less than 1 mass %; after being sprayed and treated by the primary decarbonization and desulfurization adsorption device (2), the liquid coming out from the bottom of the primary decarbonization and desulfurization adsorption device (2) is a mixture of ammonium bicarbonate with a concentration of 15 mass %-20 mass % and ammonium carbonate with a concentration of less than 1 mass %.

9. The process of claim 8, wherein the top of the primary decarbonization and desulfurization adsorption device (2) is provided with a first spray liquid inlet (21) for introducing spray liquid, and the bottom of the primary decarbonization and desulfurization adsorption device (2) is provided with a first spray liquid outlet (22) for discharging spray liquid; the top of the secondary decarbonization and desulfurization adsorption device (3) is provided with a second spray liquid inlet (31) for introducing spray liquid, and the bottom of the secondary decarbonization and desulfurization adsorption device (3) is provided with a second spray liquid outlet (32) for discharging spray liquid; the top of the tertiary decarbonization and desulfurization adsorption device (4) is provided with a third spray liquid inlet (41) for introducing spray liquid, and the bottom of the tertiary decarbonization and desulfurization adsorption device (4) is provided with a third spray liquid outlet (42) for discharging spray liquid.

10. The process of claim 1, wherein in step S3, the content of sulfur species in the blast furnace gas after decarbonization and desulfurization treatment is less than 5 ppm, and the content of carbon dioxide is less than 0.5 vol %; the concentration of CO gas after pressure swing adsorption separation by the pressure swing adsorption CO purification device (5) is greater than 98.5 vol %.
